(19) United States
(12) Patent Application Publication
(10) Pub. No.: US 2025/0146842 A1
(43) Pub. Date: May 8, 2025

(54) ANOMALY DETECTION IN DISTRIBUTED FIBER SENSING SYSTEMS USING LLMS

(71) Applicant: NEC Laboratories America, Inc., Princeton, NJ (US)

(72) Inventors: Yangmin Ding, East Brunswick, NJ (US); Ting Wang, West Windsor, NJ (US); Yue Tian, Princeton, NJ (US); Sarper Ozharar, Pennington, NJ (US); Zhuocheng Jiang, Plainsboro, NJ (US); Yanchao Wang, Princeton, NJ (US)

(21) Appl. No.: 18/932,877

(22) Filed: Oct. 31, 2024

Related U.S. Application Data
(60) Provisional application No. 63/595,839, filed on Nov. 3, 2023.

(51) Int. Cl. G01D 5/353

(52) U.S. Cl. CPC G01D 5/35358

(57) ABSTRACT

Methods and systems for anomaly detection include measuring time-series data about a system using an optical sensing system. The time-series data is adapted to natural language data. One or more anomaly detection models are selected based on the natural language data and a task. An anomaly is detected in the system using the selected one or more anomaly detection models. A corrective action is performed responsive to the anomaly.

### RELATED APPLICATION INFORMATION

This application claims priority to U.S. Patent Application No. 63/595,839, filed on Nov. 3, 2023, incorporated herein by reference in its entirety.

### BACKGROUND

### Technical Field

The present invention relates to distributed fiber sensing and, more particularly, to anomaly detection using distributed fiber sensing.

### Description of the Related Art

Distributed fiber optic sensing systems can be used to monitor large-scale infrastructure, such as pipelines, bridges, and power lines. Such systems use backscattered light signals in fiber optic cables to detect changes in the environment, which can indicate potential anomalies. A distributed fiber optic sensing system may collect and store data, which a machine learning model can use to extract features and detect anomalies.

However, complex backscattering data can be difficult to interpret, leading to false alarms and missed anomalies. Furthermore, the machine learning model may have difficulty adapting to new data and evolving circumstances. As infrastructure systems and their surrounding environments change over time, the data patterns and signatures of anomalies may also evolve. In addition, user interfaces for such systems may not provide a deep understanding of the context in which the anomalies are detected.

### SUMMARY

A method for anomaly detection includes measuring time-series data about a system using an optical sensing system. The time-series data is adapted to natural language data. One or more anomaly detection models are selected based on the natural language data and a task. An anomaly is detected in the system using the selected one or more anomaly detection models. A corrective action is performed responsive to the anomaly.

A system for anomaly detection includes a hardware processor and a memory that stores a computer program. When executed by the hardware processor, the computer program causes the hardware processor to measure time-series data about a system using an optical sensing system, to adapt the time-series data to natural language data, to select one or more of a plurality of anomaly detection models based on the natural language data and a task, to detect an anomaly in the system using the selected one or more anomaly detection models, and to perform a corrective action responsive to the anomaly.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an anomaly detection system that uses optical fiber to collect data from a system, in accordance with an embodiment of the present invention;

FIG. 2 is a block diagram of a distributed sensing system that collects information from a system by collecting data from an optical fiber, in accordance with an embodiment of the present invention;

FIG. 3 is a block diagram of a controller that performs anomaly detection using a large language model to select between anomaly detection models, in accordance with an embodiment of the present invention;

FIG. 4 is a block/flow diagram of a method of adapting time-series data into a format that can be processed by a large language model;

FIG. 5 is a block/flow diagram of a method of detecting and correcting anomalies in a system using adapted time-series data, in accordance with an embodiment of the present invention;

FIG. 6 is a block diagram of a computing device that can be used to detect and correct anomalies in a system using adapted time-series data, in accordance with an embodiment of the present invention;

FIG. 7 is a diagram of an exemplary neural network architecture that can be used to implement part of a large language model meta-model, in accordance with an embodiment of the present invention; and

FIG. 8 is a diagram of an exemplary deep neural network architecture that can be used to implement part of a large language model meta-model, in accordance with an embodiment of the present invention.

### DETAILED DESCRIPTION OF PREFERRED EMBODIMENTS

Distributed fiber optic systems can be enhanced by using a large language model (LLM) to improve anomaly detection. The LLM can be used to process and analyze time-series data generated by the distributed fiber optic sensors, providing improved accuracy, enhanced adaptability, faster processing, scalability, and cost reduction.

To this end, the time series data is converted to a form that the LLM can handle. For example, time-series data can be converted into a format that allows the LLM to understand and process the data, which helps with interpretation of large amounts of complex data. The LLM further helps to reduce false alarms in the missed anomalies output of a domain-specific anomaly detection model. The LLM acts as a meta-model that integrates the outputs from multiple anomaly detection models, creating a more comprehensive and accurate decision-making interface.

The LLM may further be tuned to consider multiple anomaly detection models and select the model which is most appropriate based on the input data and a specific use case. The LLM can further be updated based on user feedback to provide continuous learning and improvement to its anomaly detection capabilities. A context-aware graphical user interface (GUI) can be used to provide a deep understanding of detected anomalies and their surrounding environment.

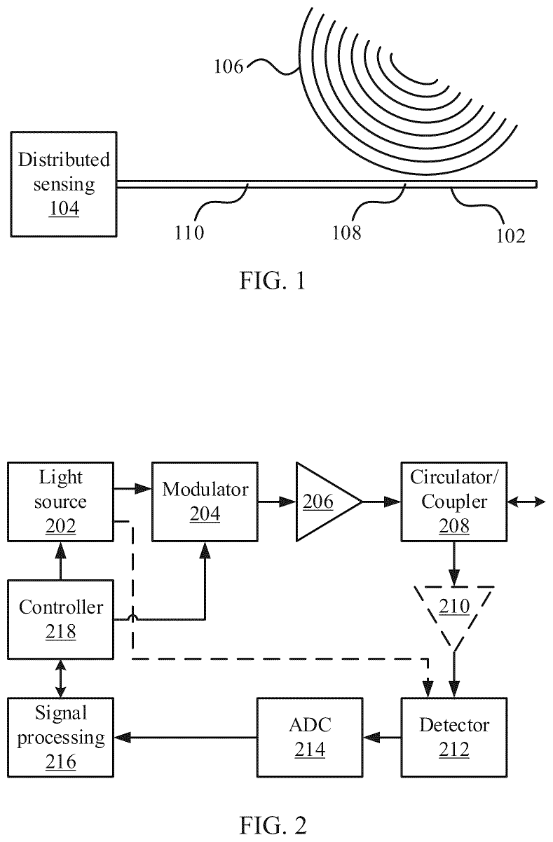

Referring now to FIG. 1, an exemplary acoustic sensor system is shown. A single optical fiber 102 is illustrated, with a distributed sensing system 104 at one end. An acoustic signal 106 is generated by a sound occurring in the vicinity of the fiber 102. As the acoustic signal 106 propagates through the surrounding medium (e.g., air), it impact the fiber 102 at different times along its length, due to the finite speed of sound through the medium. Thus, portions of the fiber 102 that are closer to the source of the acoustic signal 106 will be affected by the acoustic signal 106 sooner than portions of the fiber 102 that are farther away.

Although detection of acoustic signals by the distributed sensing system 104 is specifically described herein, it should be understood that distributed fiber optic sensing can be used to detect other types of phenomena as well. For example, impact, stretching, compression, bending, and temperature changes of the fiber 102 will also result in detectable changes in the properties of the fiber 102.

The fiber 102 may be any appropriate fiber-optic cable, such as a single-mode, few-mode, multimode, or other type of specialty cable. The fiber 102 acts as a continuous sensing element, with each section acting as a small sensor that can detect acoustic waves along its length. The fiber 102 can be wrapped in an elastic support material to increase the sensitivity and reduce the dimension, such as being wrapped around thin-wall hollow cylindrical transducers or being attached to the surface of an elastic cable.

Each point on the fiber 102 may be treated as if it were a separate sensor in an array. As an optical pulse from the distributed sensing system 104 travels along the length of the fiber 102, in this example from left to right, variations in the properties of the fiber 102 will cause reflections from the optical pulse to bounce back (scatter) to the distributed sensing system 104. The point along the fiber 102 from which the reflection originates can be determined based on the speed of light within the fiber, measured from the time the optical pulse leaves the distributed sensing system 104 to the time the reflection is received.

In some cases, these reflections are signals that can be combined to form a beam of sensitivity that focuses on a specific direction relative to the fiber 102. This direction can be selected by changing the relative phases of the combined signals and by the position of the sensing location. The positions can be selected as above, by selecting reflections that arrive at the distributed sensing system 104 at a predetermined time based on their distance from the distributed sensing system 104 along the length of the fiber 102. For example, sensing locations 108 and 110 will generate different reflections that can be differentiated from one another based on the time of arrival of those reflections from the emission of a given optical pulse.

Although the present embodiments are described with respect to a single fiber 102, it should be understood that multiple such fibers can be connected to a distributed sensing system 104 with the use of, e.g., an optical switch or wave division multiplexing. The different reflected signals from the different fibers can then be processed independently to provide sensing in multiple locations.

Referring now to FIG. 2, an exemplary distributed acoustic sensing system is shown. This system makes use of scattering-based detection, but it should be understood that alternative systems are also contemplated, such as those which use forwarding. A light source 202 (e.g., a laser) generates an optical pulse. The optical pulse is modulated by modulator 204 and is amplified by optical amplifier 206 before being launched on the fiber 102 using circulator/coupler 208.

Reflected optical signals from the fiber 102 are directed by the circulator/coupler 208, optionally through an optical amplifier 210, to detector 212. The detector 212 may make use of a local oscillator signal from the light source 202 to aid in equalization. The detector 212 converts the received signal from the optical domain to the electrical domain, generating an analog electrical signal that is converted to digital by analog-to-digital converter (ADC) 214. Signal processing 216 receives the digital signal, which may include multiple reflections over time, and uses that information to localize an event. The signal processing 216 may further provide feedback to a controller 218, which can set parameters for the light source 202 and the modulator 204 for future sensing.

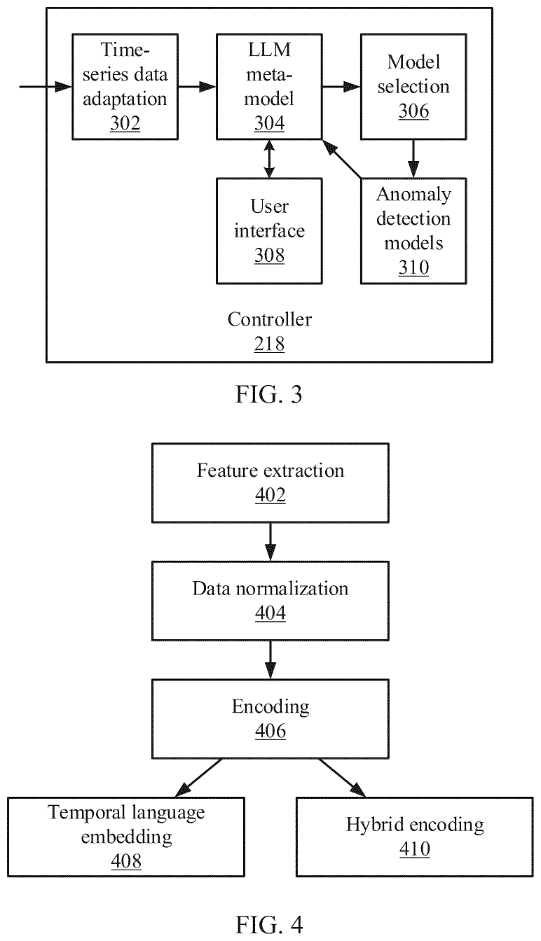

Referring now to FIG. 3, additional detail on controller 218 is shown. Information from signal processing 216, which provides time-series data collected from the fiber 102, is converted by time-series data adaptation 302 into a format that is accessible to an LLM meta-model 304. The LLM meta-model 304 performs model selection 306, picking an appropriate model from a set of pretrained models that is best suited for the circumstances and a task at hand. The LLM meta-model 304 also provides information to, and receives user feedback from, a user interface 308. The LLM meta-model 304 provides analysis and processing of the time-series data and the output of the selected model, rendering it in a form that is appropriate for the user interface 308.

The LLM meta-model 304 may be integrated with domain-specific anomaly detection models. The integration may include a model embedding, where each of the anomaly detection models is embedded into a unified feature space, with the model outputs being transformed into a format that the LLM can handle.

For example, the model may be represented as a description of the model's outputs, performance metrics, and contextual information in a unified feature space. Each anomaly detection model generates outputs when processing time-series data, and these outputs may include anomaly scores, labels, confidence levels, and detection timestamps. The outputs may be converted to a structured format that encapsulates all the relevant information. The structured outputs may then be converted to a natural language summary or description. For example, an anomaly detection model that detects a spike might be represented as, “Model A detected a significant increase in vibration levels at location X, between times T1 and T2, with a confidence score of 0.95.”

Additional metadata, such as a model's historical performance, domain of expertise, and operational parameters, may be included in the embedding. This provides the LLM with context about each model's reliability and suitability for specific tasks. By converting all of the model's outputs and metadata into consistent natural language or structured data formats, a unified feature space is created that makes it simple for the LLM to process the inputs, allowing it to compare, contrast, and integrate findings from multiple models.

The LLM meta-model 304 processes the embedded model outputs, fusing them in a context-aware manner. The fusion leverages the LLM's ability to learn complex relationships and dependencies, allowing it to combine the information from multiple models. The LLM meta-model 304 assigns dynamic weights to the individual models based on their relevance to a specific use case, data input, and historical performance. The LLM meta-model 304 thereby emphasizes the most reliable and accurate model(s) for a given situation, while reducing the influence of models which are less accurate or less relevant.

The LLM meta-model 304 may estimate a confidence level of each model's output, providing an additional layer of information that can be used to improve the overall decision making process. Transfer learning may further be used to fine-tune the LLM meta-model's integration with existing models, so that it can quickly adapt to new data and evolving situations.

For example, transfer learning may start with an LLM that is pre-trained on a general domain corpus. The pre-training equips the LLM with a broad understanding of language structures, semantics, and general knowledge. The pre-trained LLM is then fine-tuned on domain-specific data relating to sensing. This data may include technical documents, sensor data descriptions, anomaly reports, maintenance logs, and domain-specific terminology. The LLM may further be trained to interpret the natural language embeddings of the anomaly detection models' outputs. By exposing the LLM to examples of model outputs and corresponding desired interpretations or actions, it is trained to process and reason about these outputs effectively. User feedback and new data can then be incorporated to refine the LLM's performance. Transfer learning allows the LLM to adapt quickly to evolving patterns, new types of anomalies, and changes in the monitored infrastructure by updating its parameters based on additional fine-tuning datasets.

The LLM meta-model 304 processes outputs of the existing anomaly detection models to generate a more comprehensive and accurate decision making process. The LLM meta-model 304 employs a hierarchical decision making process that uses the properties of each model and the context of a specific use case to generate a recommendation for model selection 306. Data is collected from multiple sources, including the outputs of the existing models, contextual information, and user feedback. The LLM meta-model 304 uses its natural language understanding capabilities to reason about the context of detected anomalies, incorporating domain knowledge and contextual information to make informed decision.

The results provided by the LLM meta-model 304 are explainable and interpretable, so that users can better understand the rationale behind the anomaly detection decisions. To that end, the LLM meta-model 304 can generate human-readable explanations that describe the contributing factors and relationships between different models and data sources. The LLM meta-model can furthermore continuously learn and adapt its decision making process based on user feedback, historical performance, and the evolving nature of the monitored infrastructure.

Model selection 306 selects the most appropriate anomaly detection model based on a model relevance evaluation. The relevance of each anomaly detection model to the current use case and input is determined, considering factors such as the model's historical performance, the type of anomaly being detected, and the specific characteristics of the input data. The LLM meta-model 304 predicts the performance of the models, prioritizing the execution of models with the highest predicted performance.

The model selection 306 may further create ensembles of the anomaly detection models 310, combining their outputs to improve the overall anomaly detection performance. The models are selected and weighted within the ensemble based on their relevance and performance in the current context. The model selection 306 may be updated on a periodic or continuous basis to fine-tune the model selection capabilities over time.

The LLM meta-model 304 generates final anomaly detection results based on the integration and processing of the anomaly detection models 310, meta-model decisions, and model selection. A comprehensive decision output includes not only the final anomaly detection decision from the model(s), but also offers additional information such as confidence scores, contributing factors, and any detected patterns or trends. Alerts can be generated for the user interface 308 that are tailored to the specific use case and needs for the end-users, for example based on user feedback. The input data and anomaly detection results can be processed in real-time, so that system status is always up to date.

The LLM meta-model 304 monitors performance using key performance indicators such as precision, recall, and an F1 score. By identifying areas where improvements can be made, the LLM meta-model 304 ensures that the system remains fine-tuned and prioritizes areas for further development. The LLM meta-model 304 may update the anomaly detection models 310 to update the models and to incorporate new models as needed.

Referring now to FIG. 4, additional detail on time-series data adaptation 302 is shown. Block 402 extracts features from raw time-series data, such as statistical features (e.g., mean, variance, and autocorrelation), frequency-domain features (e.g. spectral analysis), and time-domain features (e.g., wavelet analysis). Block 404 normalizes the data, for example by scaling the extracted features to a standard range (e.g., between zero and one or between one and negative one) to ensure that the LLM meta-model 304 can effectively learn from the data without bias toward specific features.

Block 406 encodes the normalized features in a format that the LLM can process. In one example, temporal language embedding 408 maps time-series data values to a predefined vocabulary of words or phrases, taking into account the temporal relationships between the data points. This allows the LLM to process the time-series data as if it were a natural-language text.

The temporal language embedding translates numerical time-series data into natural language narratives that reflect underlying patterns, events, and temporal relations in the data. The words and phrases of the predefined vocabulary are selected to accurately and meaningfully represent the specific data points and patterns observed in the time-series data.

The temporal language embedding can be performed by binning numerical data points into ranges. Each bin is associated with a descriptive token. Common patterns in the data, such as spikes, drops, and steady trends may be identified using statistical or signal processing techniques and may be mapped to corresponding descriptive phrases. Temporal relationships may further be encoded, preserving time components of the data by structuring the tokens in the sequence to reflect the order and duration of events. Special tokens or phrases may be used to indicate temporal transitions, such as, “sudden increase,” “gradual decline,” or “periodic fluctuation.” The descriptive tokens and temporal markers may be combined to form sentences or phrases that narrate the time-series data. The vocabulary may be designed to represent specific data characteristics and patterns that are relevant to anomaly detection. Domain-specific terminology may be included to ensure that the descriptions are meaningful, e.g., within the context of fiber optic sensing.

In another example, hybrid encoding 410 combines multiple encoding methods, such as text-based encoding and vector space embeddings, to create a hybrid representation that captures both discrete and continuous aspects of the data. This helps the LLM to better understand the nuances of the time-series data, providing improved anomaly detection performance.

The hybrid representation may include both natural language descriptions and numerical vector embeddings of the time-series data to take advantage of the strengths of each format. The time-series data may be processed to extract numerical features, such as statistical measures, frequency components, or other relevant quantitative details. These details may then be encoded into numerical vectors. The data may also be translated into natural language descriptions that capture patterns, trends, or significant events in the data, as described above.

The combined representation allows the LLM to process the precise numerical information and the contextual, qualitative insights provided by the text. Whereas the temporal language embedding focuses solely on converting time-series data into natural language sequences, potentially losing some granular numerical details in the process, the hybrid representation retains the exact numerical values alongside the textual descriptions, thereby providing a more comprehensive input. By integrating both textual and numerical data, the LLM uses its language understanding abilities while also considering detailed quantitative information, enhancing its ability to detect anomalies and interpret complex data patterns accurately.

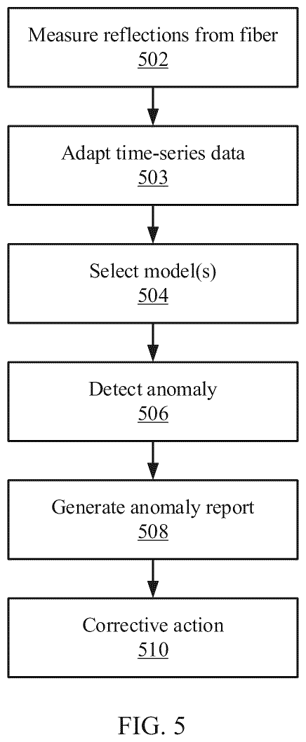

Referring now to FIG. 5, a method for anomaly detection and correction is shown. Block 502 measures reflections from the fiber 102, for example producing time-series data that can be used to determine the location(s) of changes in the conditions around the fiber 102. This generates time-series data that block 503 adapts to a form that the LLM meta-model 304 can accept, such as by temporal language embedding 408 or by hybrid encoding 410.

Block 504 selects a model from the anomaly detection models, based on the received data and the task at hand. The model selection process involves the LLM meta-model evaluating and choosing the most suitable anomaly detection model based on the specific task and input data characteristics. To determine relevance, the LLM first characterizes the task at hand by defining the anomaly detection objectives (e.g., detecting fiber breaks, temperature fluctuations), considering operational constraints (such as real-time processing requirements or acceptable false alarm rates), and assessing contextual factors like environmental conditions.

Each available anomaly detection model is profiled based on its specialization, historical performance metrics (accuracy, precision, recall), data requirements, and operational efficiency. The LLM analyzes how well each model's capabilities align with the task objectives and the nature of the current data, including factors like data type compatibility and the model's effectiveness in similar scenarios.

By matching the task requirements with the models' profiles, the LLM determines relevance by assessing the alignment between the models' expertise and the specific needs of the task. It considers factors such as the models' past success in detecting relevant anomalies, their adaptability to current data patterns, and their resource efficiency. The LLM then selects the model—or an ensemble of models—that best fits the task, ensuring accurate and efficient anomaly detection. This selection process enhances the system's ability to detect anomalies effectively by leveraging the most appropriate tools for the specific situation.

Using the selected model (or combination of models), block 506 detects an anomaly based on the data received from the fiber. For example, the data may identify an change in the conditions of the fiber 102, which may correlate to known dangerous conditions or which may reflect unknown circumstances. Block 508 generates an anomaly report based on this detection, providing information relating to the detection (e.g., location and time) and any information that can put the anomaly into context (e.g., identifying a type of anomaly).

Based on the detection of the anomaly, block 510 performs a corrective action. The corrective action may include an automatic change to an operational or environmental parameter of a system that is being monitored. For example, the corrective action may include turning a given machine on or off, changing the local temperature or humidity, or automatically engaging safety measures responsive to a detected anomaly in a potentially hazardous area.

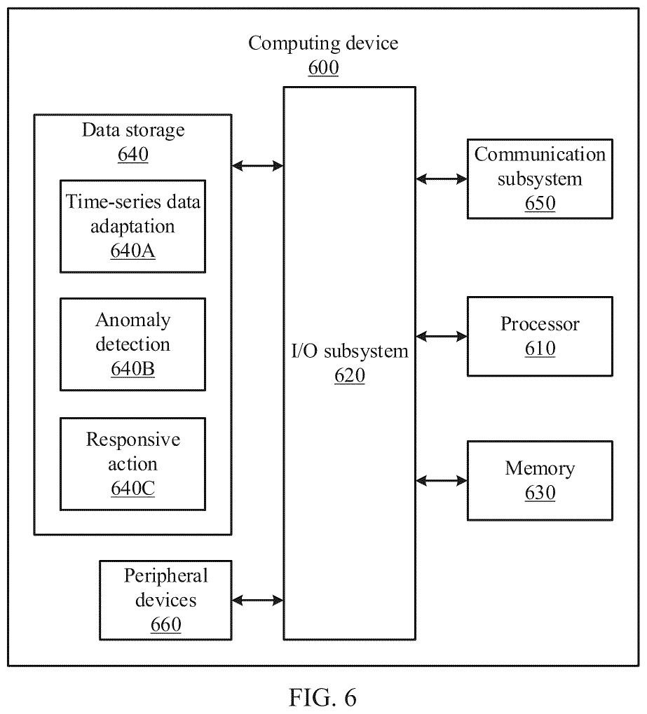

Referring now to FIG. 6, an exemplary computing device 600 is shown, in accordance with an embodiment of the present invention. The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for time-series data adaptation, 640B for performing anomaly detection, and/or 640C for performing corrective action. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

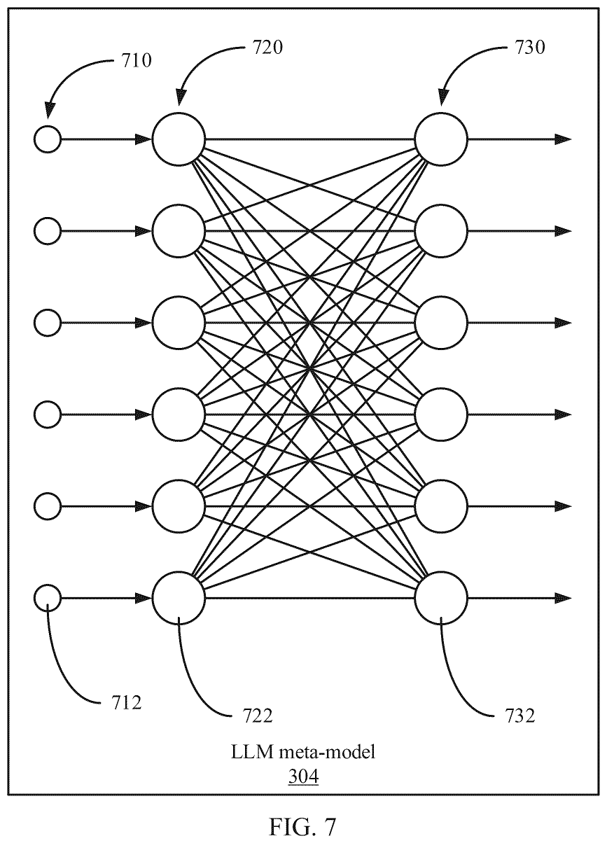

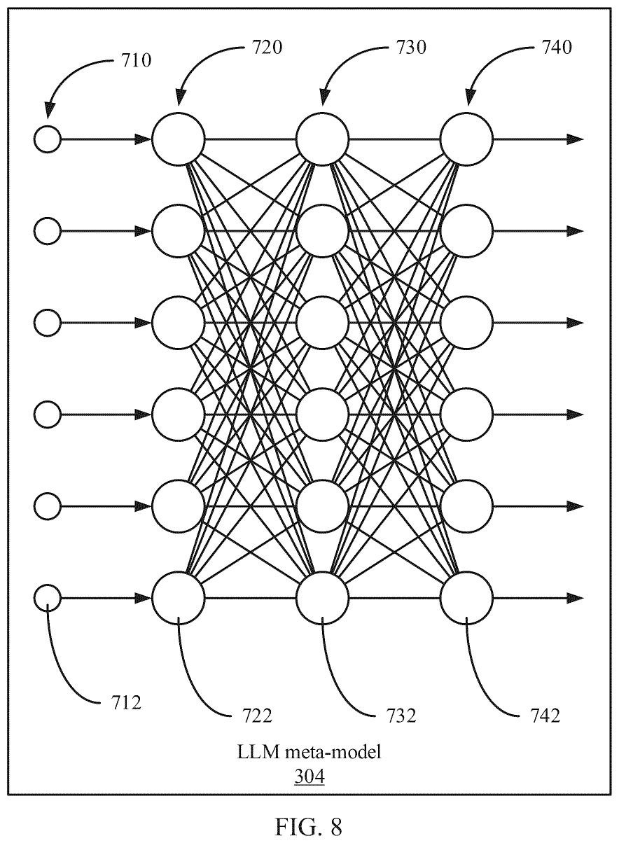

Referring now to FIGS. 7 and 8, exemplary neural network architectures are shown, which may be used to implement parts of the present models, such as the dynamic segmentation model 700/700. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 732 in the one or more computation (hidden) layer(s) 730 perform a nonlinear transformation on the input data 712 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for anomaly detection, comprising:
measuring time-series data about a system using an optical sensing system;
adapting the time-series data to natural language data;
selecting one or more of a plurality of anomaly detection models based on the natural language data and a task;
detecting an anomaly in the system using the selected one or more anomaly detection models; and
performing a corrective action responsive to the anomaly.

2. The method of claim 1, wherein adapting the time-series data to natural language data includes temporal language embedding.

3. The method of claim 2, wherein temporal language embedding includes a mapping of time-series data values to a predefined vocabulary of words or phrases based on temporal relationships between data points.

4. The method of claim 1, wherein adapting the time-series data to natural language data includes hybrid encoding of natural language descriptions and numerical values.

5. The method of claim 1, wherein selecting is performed using a large language model that accepts the natural language data as input.

6. The method of claim 1, further comprising representing the plurality of anomaly detection models in natural language, wherein selecting the one or more of the plurality of anomaly detection models is performed using a large language model.

7. The method of claim 6, wherein representing the plurality of anomaly detection models in natural language includes a description of an output and performance metric of each anomaly detection model.

8. The method of claim 1, wherein the optical sensing system includes an optical fiber and wherein measuring time series data includes emitting an optical pulse on the optical fiber.

9. The method of claim 1, wherein selecting the one or more of the plurality of anomaly detection models includes weighting the plurality of anomaly detection models based on their relevance to a specific use case, data input, and historical performance.

10. The method of claim 1, wherein the corrective action is selected from the group consisting of turning a given machine on or off, changing a local temperature or humidity, or automatically engaging safety measures responsive to a detected anomaly in a potentially hazardous area.

11. A system for anomaly detection, comprising:
a hardware processor; and
a memory that stores a computer program which, when executed by the hardware processor, causes the hardware processor to:
measure time-series data about a system using an optical sensing system;
adapt the time-series data to natural language data;
select one or more of a plurality of anomaly detection models based on the natural language data and a task;
detect an anomaly in the system using the selected one or more anomaly detection models; and
perform a corrective action responsive to the anomaly.

12. The system of claim 11, wherein the adaptation of the time-series data to natural language data includes temporal language embedding.

13. The system of claim 12, wherein the temporal language embedding includes a mapping of time-series data values to a predefined vocabulary of words or phrases based on temporal relationships between data points.

14. The system of claim 11, wherein the adaptation of the time-series data to natural language data includes hybrid encoding of natural language descriptions and numerical values.

15. The system of claim 11, wherein the selection is performed using a large language model that accepts the natural language data as input.

16. The system of claim 11, wherein the computer program further causes the hardware processor to represent the plurality of anomaly detection models in natural language, wherein the selection of the one or more of the plurality of anomaly detection models is performed using a large language model.

17. The system of claim 16, wherein the representation of the plurality of anomaly detection models in natural language includes a description of an output and performance metric of each anomaly detection model.

18. The system of claim 11, wherein the optical sensing system includes an optical fiber and wherein the measurement of the time-series data includes emitting an optical pulse on the optical fiber.

19. The system of claim 11, wherein the selection of the one or more of the plurality of anomaly detection models includes weighting the plurality of anomaly detection models based on their relevance to a specific use case, data input, and historical performance.

20. The system of claim 11, wherein the corrective action is selected from the group consisting of turning a given machine on or off, changing a local temperature or humidity, or automatically engaging safety measures responsive to a detected anomaly in a potentially hazardous area.
